(19) United States
(12) Patent Application Publication
(10) Pub. No.: US 2003/0050836 A1
(43) Pub. Date: Mar. 13, 2003

(54) Method of providing a product to a consumer with targeted information

(76) Inventor: Evan Gardner Eckman, Germantown, TN (US)

Correspondence Address: Allen R Kipnes, Watov & Kipnes, P O Box 247, Princeton Junction, NJ, 08550, US

(21) Appl. No.: 10/110,363

(22) PCT Filed: Sep. 17, 2001
(86) PCT No.: PCT/US01/29015

(51) Int. Cl. G06F 17/60

(52) U.S. Cl. 705/14

(57) ABSTRACT

A method for providing a consumer with a product or service contained with a container having an inside surface in which the inside surface contains one or more advertisements tailored to the purchasing tendencies of the particular consumer.

### FIELD OF THE INVENTION

The present invention is directed to a method of providing a consumer with a product contained with a container wherein, based on information which may be tailored to a target group encompassing the consumer, the container comes with preselected targeted information such as advertising containing information regarding products, services and/or companies which is likely to be of particular interest to the consumer and which is positioned only on at least a portion of the inside surface of the container.

### BACKGROUND OF THE INVENTION

It is well known that consumers can obtain products without having to physically enter a store. Mail order companies have been in operation for many years. Consumers obtain catalogs from the mail order companies and then purchase products by placing an order by a variety of methods including telephone, facsimile, e-mail, letter and the like. When the order is obtained by the mail order company (i.e. product and/or service provider), the product is obtained from a source (e.g. the manufacturer and/or distributor of the product), packaged in an appropriate shipping container and then shipped to the consumer. Typically, in addition to paying shipping charges, the price of the product includes the cost of the container and other incidental costs associated therewith.

Mail order companies are known to keep records of consumer purchases and to forward to consumers advertisements of the products (e.g. copies of the mail order catalog) available through the mail order company. In some cases, the advertisements may reflect consumer purchase preferences (e.g. a consumer who purchases golf balls may be sent product advertisements for golf equipment or even golf club membership information).

More recently, the Global Computer Information Network (hereinafter “Internet”) has provided an alternative to mail order purchasing. The consumer accesses a website of the product provider and scrolls to a page directed to the desired product and/or service, views the desired product from products which are available and places an order for the product. The product provider processes the order, obtains the product from inventory or a suitable product source (e.g. manufacturer and/or distributor), packages the product in a suitable shipping container and then forwards the product to the consumer in much the same way as a mail order company. The Internet based product provider as described above employs a website which typically advertises products and/or services that are available from the product provider. As with mail order companies, the Internet based product provider can generate or obtain consumer preferences for products and provide advertisements for those products made available by the product provider through the Internet and/or through advertisements which can be packaged with the purchased product.

With the increasing use of non-retail store means of purchasing products by consumers including use of mail order companies and the Internet, there is a growing need to generate new methods of providing the consumer with desirable and preferably consumer tailored information designed to spur purchases (e.g. advertisements) in a cost efficient and effective manner and to provide the opportunity for product providers (e.g. mail order companies, Internet-based product providers and the like) to increase revenues which may be used to at least in part offset the cost of shipping and handling consumer purchases.

### SUMMARY OF THE INVENTION

The present invention is generally directed to a method of providing a product or service to a consumer in a container with an inside surface having preselected targeted information (such as in the form of advertisements) thereon which brings to the attention of the consumer, products and/or services which may be of interest to the consumer based on specific information obtained about the consumer (i.e. target group identifying information). The manner in which the present method is conducted can generate an additional source of revenue which may be used, for example, to offset the cost of shipping and handling of consumer purchases.

In a particular aspect of the present invention, there is provided a method of providing a consumer a product or service suitably packaged within a container with preselected targeted information comprising:

a) obtaining an order for a product or service from a consumer;

b) obtaining target group identifying information from the consumer sufficient to identify the consumer as a member of at least one target group;

c) identifying preselected targeted information which is of interest to the target group of which the consumer has been identified as a member;

d) placing the preselected targeted information on at least a portion of an inside surface of the container; and

e) shipping the container having the product or service therein to the consumer, wherein when the consumer opens the container the preselected targeted information is visible to the consumer.

### DETAILED DESCRIPTION OF THE DRAWING

The following drawings are illustrative of embodiments of the present invention and is not intended to limit the invention as disclosed in the application.

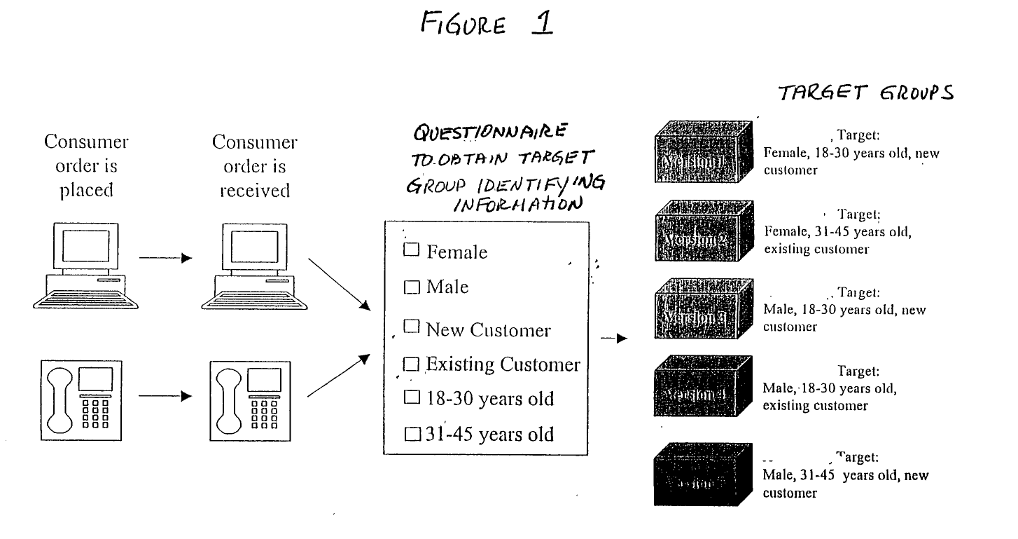

FIG. 1 is a diagrammatic view of an embodiment of the method of the present invention; and

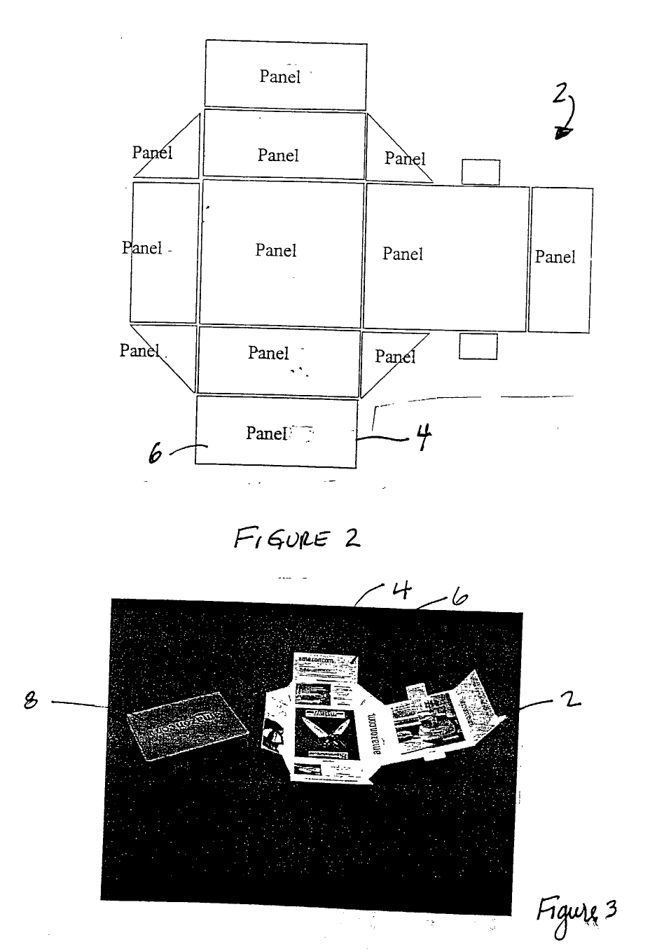

FIG. 2 is a schematic view of the inside surface of a container that may be used in the method of the present invention; and

FIG. 3 is a photograph similar to FIG. 2 showing the inside surface of the container with advertising thereon.

### DETAILED DESCRIPTION OF THE INVENTION

The present method is best understood by reference to FIG. 1 which shows in diagrammatic form an embodiment of the operation of the method of the present invention from the purchase of a product or service by a consumer to receipt of the product or service with preselected targeted information. It will be understood that the method of the present invention applies to the sale of products, services or combinations thereof. The sale of services may be represented by a certificate of given monetary value which may be exchanged for the performance of services by a service provider.

The participants in the method are a container supplier whose principle function is to provide suitable container for products and/or services (hereinafter generally referred to as “products”) offered by a product provider so that the products may be safely shipped to the consumer. The product provider is responsible for obtaining orders for products from the consumer, packaging the product in the container and shipping the packaged product to the consumer. The source of the product (hereinafter “product source”) which may be the same as the product provider is typically a manufacturer and/or distributor of the product.

In accordance with the present invention, there is also provided preselected targeted information such as advertisements physically associated with up to the entire inside surface of the container which is particularly adapted and consistent with the purchasing preferences of the consumer which, as hereinafter explained, will be characterized as belonging to one or more target groups. The preselected targeted information is selected according to which target group or groups the particular consumer is a member as determined by target group identifying information received from the consumer.

The preselected targeted information is physically associated with the inside surface of the container and will be observed by the consumer when the container is opened to reveal the product. The preselected targeted information may, for example, cover virtually any product and/or service and may provide information about a company. The information may relate to a single product or service or multiple products and/or services from one or more companies. In a preferred form of the present invention, the preselected targeted information as provided on the inside surface of the container will be paid for by the product source.

The present method provides a new method of providing preselected target information concerning products, services, and/or information which may be relevant to the consumer that has been matched with particular consumer preferences. The physical embodiment of the preselected targeted information is physically associated with the inside surface of the shipping container such as in the form of an advertisement label and provides the consumer with valuable information which can enable the product provider to obtain a new source of revenue which may be used to offset the cost of shipping and handling like.

The present method enables product sources (e.g. manufacturers and distributors) to place information about their products before pre-qualified purchasers in a new and effective way. The preselected targeted information is obtained typically by the product provider (e.g. mail order company) directly or from sources available to the product provider (e.g. marketing consultants). The information obtained from the consumer (hereinafter “target group identification” information) includes, but is not limited to, specific details of consumer preferences for products, services and companies and the like as well as information such as gender, age, type of customer (e.g. new or existing) and financial background of the consumer that can be used to define the consumer as a member of a target group. The members of the target group (e.g. females; age 16-30; $30,000-$50,000 income bracket) will generally exhibit common purchasing tendencies.

The preselected targeted information can be obtained from actual consumer purchases or other information as described above which may be available about the consumer through the use of questionnaires or other sources of information. The companies that will pay for the preselected target information and its appearance on the inside surface of the shipping container (e.g. manufacturer and/or distributor of the product) therefore can direct information about their products and/or company to a select group of consumers which already have been qualified as likely to favorably receive such information.

The container supplier provides containers for shipping the goods or services. The preselected targeted information based on target group identification information is physically associated with the container placed on at least a portion of the inside surface of the container. Accordingly, when the consumer receives the container, the consumer will see the preselected targeted information when he or she opens the container. In this regard, the container may be tailored to maximize exposure of the preselected targeted information to the consumer during the consumers unpackaging of the ordered product by the positioning of the preselected targeted information on one or more panels of the inside surface of the container.

The “preselected targeted information” includes any information whether written or graphic which is of interest to a consumer of one or more target groups. A most common example or preselected targeted information is an advertisement for a product and/or service offered by the product provider, the product source or some other company including the container provider. It will be understood that other types of information may be included as preselected targeted information including but not limited to games, community information, and the like.

Referring to FIG. 1, there is shown a schematic view of an embodiment of the method of the present invention. In accordance with said method, a consumer places an order with a service provider such as a mail order company, an Internet provider of products or services or the like. The order may be placed by any convenient means such as telephone, facsimile, Internet communication, or any other means provided by the product provider. When the order is received, the product provider may seek to obtain information from the consumer (target group identifying information) for the purpose of placing the consumer in at least one target group. The target group will eventually be matched with preselected targeted information for distribution to the consumer as explained hereinafter.

The target group identifying information may include any information which is relevant to the definition of the targeted group. As shown in the embodiment of FIG. 1, the questions provided include the gender of the consumer, whether the consumer is a new or existing customer and the age bracket of the consumer. It will be appreciated that other categories of target group identifying information may be requested. The more information provided about the consumer, the more closely related the members of the target group become and the more likely that they will have similar purchasing tendencies.

The product provider obtains or creates characteristics of target groups. Each target group is therefore based on certain categories of target group identifying information that are provided by the consumers. By way of example and again referring specifically to FIG. 1, there are shown five target groups based on the information provided by the consumer which constitutes the preselected target information. Thus, one target group includes consumers who are female, 18-30 years old and a new customer. Another target group includes males, 31-45 years old which are new customers. It will be appreciated that FIG. 1 shows only five of the possible eight target groups that can be created by the target group identifying information requested from the consumer through the questionnaire.

Once the consumer is identified as being a member of at least one target group, the product provider matches the consumer of that target group with preselected targeted information which is particularly adapted and believe useful for the particular target group. By way of example, the target group comprised of females of 18-30 years old may receive preselected targeted information such as advertisements for young women's clothing, shoes and the like. By contrast, the target group comprised of males 31-45 years old (whether new or old customers) may receive preselected targeted information relating to sporting goods, sporting events and the like. The matching of a target group to particular preselected targeted information can be accomplished in a variety of ways known in the art. The matching may be accomplished based on personal experience, data about consumer purchasing or by business organizations in the field such as marketing consultants and the like.

It will be appreciated that the matching of target group identifying information from the consumer and preselected targeted information provided by the product provider such as in the form of advertisements may not be limited to a consumer questionnaire but may include a host of research information provided by the product provider or obtained from an outside source such as a consumer marketing organization. What is important to the method of the claimed invention is that the target group identifying information be matched to members of a target group so that when the container for the desired product is received by the consumer, the preselected targeted information has a higher probability of being of interest to the particular consumer than if it were randomly selected.

Once the product provider identifies the consumer as part of at least one target group, and the preselected target information (e.g. advertisement) is selected for that consumer, the preselected targeted information is provided on the inside surface of a container used to ship the ordered product or service to the consumer.

Referring to FIGS. 2 and 3, and first to FIG. 2 there is shown a blank 2 for forming a typical container for shipping an ordered product or service to the consumer. The blank 2 contains a series of panels 4 having inside surfaces 6 in which in the particular embodiment shown in FIG. 2 there are twelve such panels. One or more of the panels may be used to display the preselected targeted information. In a preferred form of the invention as shown specifically in FIG. 3, the entire inside surface of the container, constituting all twelve panels is used to display the preselected targeted information. It will be understood that the inside surface of the package may be used to display one or more separate items of preselected targeted information including separate and distinct products and/or services, as well as other information which is likely to be of interest to a member of the particular target group. The block 2 when folded together forms a shipping container 8 as shown in FIG. 3.

The preselected targeted information is limited to the inside surface of the container so as not to interfere with or in any way encumber the mailing information which typically appears on the outside surface of a container used for shipping. In addition, by placing the target information solely within the inside surface, the consumer not only enjoys opening the package to receive the ordered product or service but has the additional benefit of being “surprised” by the information contained on the inside surface of the container which is not otherwise visible until the container is open.

In accordance with a further aspect of the present invention, the placing of the preselected targeted information which is particularly geared to a member of the target group on the inside surface of the package can provide an additional source of revenue to the product provider. In particular, if the preselected targeted information relates to products and/or services of a company, the company may be charged for the right to have their particular preselected targeted information on the container which will enable the product provider or to have an additional source of income. This income may be used to offset the cost normally associated with shipping the container including the cost of the carton, shipping costs and incidental costs associated therewith.

What is claimed is:

1. A method of providing a consumer a product or service suitably packaged withing a container with preselected targeted information comprising:
a) obtaining an order for a product or service from a consumer;
b) obtaining target group identifying information from the consumer sufficient to identify the consumer as a member of at least one target group;
c) identifying preselected targeted information which is of interest to the target group of which the consumer has been identified as a member;
d) placing the preselected targeted information on at least a portion of an inside surface of the container with the preselected targeted information; and
e) shipping the container having the product or service therein to the consumer, wherein when the consumer opens the container of the preselected targeted information is visible to the consumer.

2. The method of claim 1 wherein step (b) comprises requesting the consumer to answer questions and matching the information from the answers to preselected groupings of information which define particular target groups to thereby identify the consumer as a member of at least one target group.

3. The method of claim 1 wherein the preselected targeted information is an advertisement for a product or service.

4. the method of claim 1 wherein the entire inside surface of the package is provided with the preselected targeted information.

5. The method of claim 1 wherein the inside surface of the container comprises a plurality of panels, each panel adapted to have thereon preselected targeted information.

6. The method of claim 1 further comprising charging a fee to have said preselected targeted information placed on the inside surface of the container.

7. The method of claim 2 wherein the preselected questions concern the consumer's gender, age and whether the consumer is a new customer or existing customer.

8. The method of claim 1 wherein step (a) comprises the consumer ordering a product or service through the global communications network.
